(19) United States
(12) Patent Application Publication
(10) Pub. No.: US 2025/0042454 A1
(43) Pub. Date: Feb. 6, 2025

(54) INTELLIGENT MANAGEMENT AND CONTROL SYSTEM FOR RAIL TRANSIT OPERATION SAFETY

(71) Applicant: CASCO SIGNAL LTD., Shanghai (CN)

(72) Inventors: Xiaoyong WANG, Shanghai (CN); Liang PAN, Shanghai (CN); Shaowen CHEN, Shanghai (CN); Huaxiang LIU, Shanghai (CN); Jing YUAN, Shanghai (CN)

(21) Appl. No.: 18/719,131

(22) PCT Filed: Nov. 30, 2022
(86) PCT No.: PCT/CN2022/135639

§ 371 Date: Jun. 12, 2024

(30) Foreign Application Priority Data
Feb. 28, 2022 (CN) 202210183919.3

(51) Int. Cl. B61L 27/20; B61L 25/02; B61L 27/70

(52) U.S. Cl. CPC B61L 27/20; B61L 25/025; B61L 27/70

(57) ABSTRACT

The present invention relates to a intelligent management and control system for rail transit operation safety, wherein the system, together with a train control system, an operation and maintenance terminal and a passenger information system, monitors rail transit operation risks in real time, wherein the management and control system includes a main module, a terminal interface module, a security gateway, and an information release gateway; the main module is connected to the terminal interface module, the security gateway, and the information release gateway respectively; the terminal interface module is connected to the operation and maintenance terminal; the security gateway is connected to the train control system; and the information release gateway is connected to the terminal interface module and the passenger information system respectively. Compared with the prior art, the present invention has the advantages of unified platform, high efficiency and simplified management and control process.

### FIELD OF TECHNOLOGY

The present invention relates to a rail transit signal control technology, in particular to a intelligent management and control system for rail transit operation safety.

### BACKGROUND

Operation management of rail transit focuses on train running safety and passenger services, and critical positions include a control center dispatcher, a station attendants and a station attendant, train crew; train yard staff, maintenance and engineering construction personnel. In a process of rail transit operation, a control center is used as a train running command center to issue dispatching commands, monitor device states, command emergency treatments, etc. A station level is mainly responsible for management of station level devices, such as a station signal device, a comprehensive supervision, a device for wind, water or electricity, a platform door, an escalator, while an inspector on a platform is mainly responsible for passenger services, opening or closing and protection of the platform door in an emergency situation, and safety protection of passengers when getting on and off a train. The train crew are mainly responsible for monitoring safety operation of the train and the passenger services in the train. The train yard staff are responsible for inbound and outbound of the train and a shunting work of the train in the station, etc. The maintenance and engineering construction personnels are responsible for maintaining a health state of a device and carrying out a construction work.

This hierarchical management and control manner has a clear architecture and clear division of labor. However, there are still some cases in which information asymmetry among different positions leads to safety risks, such as:
1. information owned by each position is asymmetrical, which is easy to produce an understanding deviation. When an event is triggered, information seen by each position is inconsistent. For example, when the train stops in an emergency, a driver sees that the train has no speed code, while a central traffic dispatcher may see front section occupancy.
2. Timeliness of information is not uniform and synchronization quality is poor. When an event is triggered, the time that each position receives an event alert is different. If the train stops in an emergency, the driver is the first one to notice; then the central traffic dispatcher can receive an event alarm: while the station attendants may not be aware of the specific event at all.
3. An operation risk management and control process is complicated, and contact and confirmation time is long. When an event is triggered, on-site personnel need to report to the center dispatcher, and the dispatcher then communicates with the on-site personnel to know a process and impact degree of the event, and the dispatcher makes a comprehensive decision according to an actual operation situation and issues a corresponding treatment command.
4. A treatment process is not uniform, and in some cases, it is completely dependent on personal judgment. Due to difference in personnel quality and work experience, a different treatment person may adopt a different process when dealing with the same event, which may cause secondary hazards.

### SUMMARY

The purpose of the present invention is to provide a intelligent management and control system for rail transit operation safety in order to overcome the defects existing in the prior art.

The purpose of the present invention can be realized by the following technical solutions:

According to an aspect of the present invention, provided is a intelligent management and control system for rail transit operation safety, wherein the system, together with a train control system, an operation and maintenance terminal and a passenger information system, monitors rail transit operation risks in real-time, wherein the management and control system includes a main module, a terminal interface module, a security gateway, and an information release gateway: the main module is connected to the terminal interface module, the security gateway and the information release gateway respectively: the terminal interface module is connected to the operation and maintenance terminal: the security gateway is connected to the train control system; and the information release gateway is connected to the terminal interface module and the passenger information system respectively.

As a preferred technical solution, the main module identifies a possible operation safety risk according to acquired fault information, train operation information and train positioning information, and generates a corresponding countermeasure on the basis of an emergency plan or a predefined rule.

As a preferred technical solution, the main module forwards a received relevant zone management and control command to the train control system by means of the security gateway, locks down a relevant zone, records and stores a risk event log, identifies a risk and a device fault state, and provides risk prompt information; and at the same time, the main module monitors an operation process of an operation participant, and transmits a relevant zone unlocking command to the train control system to resume the operation in time after confirming that a risk mitigation measure is executed properly.

As a preferred technical solution, the terminal interface module is deployed in a handheld device or a workstation as a human-machine interface, and is used to query states and positions of various devices in operation, to receive and push a device fault state, a risk prompt and safety operation process information for mitigating the risk provided by an operation management system, accept manually confirmed acknowledgment emergency plan operation step information, and provide emergency plan operation process monitoring information for the main module.

As a preferred technical solution, the security gateway, as a security interface between the main module and the train control system, is used to ensure secure information transmission.

As a preferred technical solution, the information release gateway is used to push device fault information to the passenger information system in time, so as to share emergency information in real time.

As a preferred technical solution, the train control system transmits a line operation state to the intelligent management and control system for rail transit operation safety in real time, and receives a zone locking command from the intelligent management and control system for rail transit operation safety at the same time, so as to activate a line safety protection function in time; and once the train control system determines that a wayside device is fault, the train control system automatically locks down a relevant zone and transmits a relevant fault state and locking state information to the main module.

As a preferred technical solution, the operation and maintenance terminal comprises a station personnel terminal and a train worker terminal, and the terminal interface module receives in real time risk information transmitted by the station personnel terminal and the train worker terminal, selects a corresponding risk event or records a risk event by means of voice, transmits a command for locking down an associated platform zone or interval to the train control system by means of the main module, and transmits information pertaining to the risk event and the relevant risk zone to a control center.

As a preferred technical solution, the operation and maintenance terminal comprises a station attendant terminal, wherein after the station attendant terminal executes an operation according to risk mitigation operation prompt step information provided by the terminal interface module, the main module transmits a push for requesting state confirmation to a dispatching terminal; and after the dispatching terminal confirms that the risk is relieved, the dispatching terminal transmits an unlocking command to the train control system to resume operation in time.

Compared with the prior art, the present invention has the following advantages:
(1) The present invention improves the accuracy of operational risk management and control, quickly responds with an emergency plan, minimizes the impact of risks, and better protects the safety of passengers and the train. On this basis, the information sharing mechanism, coordination response mechanism and emergency command mechanism are strengthened, a working mechanism of coordination response, rapid response and scientific treatment are established, the ability of the operation unit to deal with emergencies in first time is strengthened, and the casualties and property losses that may be caused by emergencies are minimized.
(2) The present invention provides a unified platform for operation and support staff to work on the same platform with consistent interfaces, consistent information displays and consistent operation manners.
(3) The present invention has high efficiency, and when an event is triggered, each position receives the event state and treatment command and so on in real time at the same time to ensure timely and effective information.
(4) The present invention simplifies the management and control process, and with the help of the unified platform, can complete a closed-loop control such as event reporting, command issuing, event treatment state feedback.

(5) The present invention unifies treatment processes, and through the information release function, each position can receive the standardized treatment process at the same time.

### BRIEF DESCRIPTION OF THE DRAWINGS

FIG. 1 is a schematic structural diagram of the present invention;

FIG. 2 is a schematic diagram of system external interfaces of the present invention; and

FIG. 3 is an activity diagram of safe intelligent management and control for operation of the present invention.

### DESCRIPTION OF THE EMBODIMENTS

The following is a clear and complete description of the technical solutions in the embodiments of the present invention in combination with accompanying drawings attached to the embodiments of the present invention. Obviously, the embodiments described are a part of the embodiments of the present invention, but not the whole embodiments. On the basis of the embodiments of the present invention, all other embodiments obtained by a person skilled in the art without creative labor shall fall within the protection scope of the present invention.

The present invention monitors rail transit operation risks in real-time by utilizing a safe intelligent management and control platform system for rail transit. The main purpose is to jointly prevent and control degrading, emergency and other abnormal operation processes. The safe intelligent management and control platform system for rail transit makes full use of real-time device fault data provided by a built intelligent operation and maintenance platform, combines a train operation plan and operation information of a dispatching system, and real-time position information of various trains including an engineering train and a shunting train provided by a train positioning system of the whole network; and carries out risk identification, classification and judgment, establishes a protection strategy from a system level, and pushes relevant protection information to a central dispatcher, station staff and train crew in a timely manner to achieve mutual control among the center, station and train. The present invention improves the accuracy of operational risk management and control through technical means, quickly responds with an emergency plan, minimizes the impact of risks, and better protects the safety of passengers and the train. On this basis, the information sharing mechanism, coordination response mechanism and emergency command mechanism are strengthened, a working mechanism of coordination response, rapid response and scientific treatment are established, the ability of the operation unit to deal with emergencies in first time is strengthened, and the casualties and property losses that may be caused by emergencies are minimized.

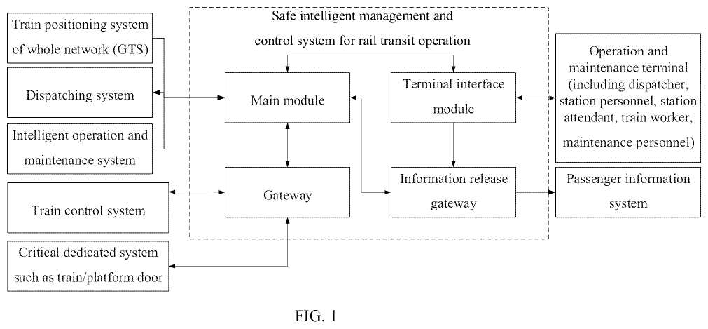

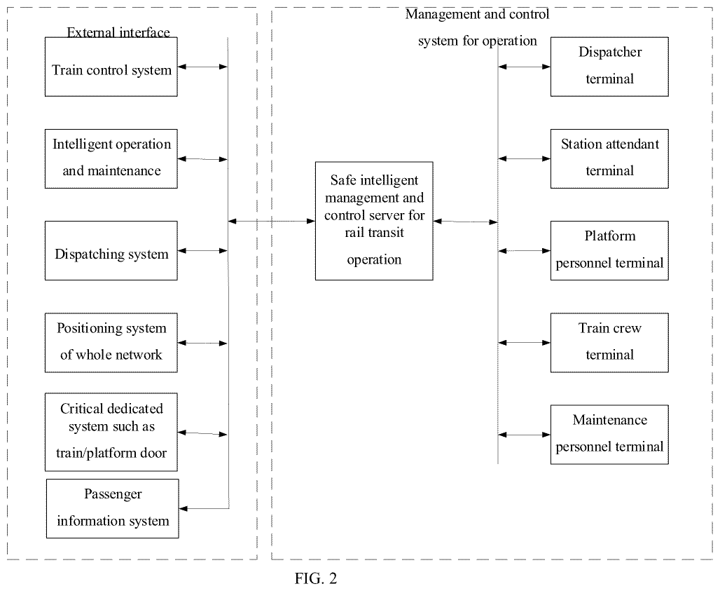

As shown in FIG. 1 and FIG. 2, a intelligent management and control system for rail transit operation safety, wherein the system, together with a train control system, an operation and maintenance terminal and a passenger information system, monitors rail transit operation risks in real-time, wherein the management and control system includes a main module, a terminal interface module, a security gateway, and an information release gateway: the main module is connected to the terminal interface module, the security gateway and the information release gateway respectively: the terminal interface module is connected to the operation and maintenance terminal: the security gateway is connected to the train control system; and the information release gateway is connected to the terminal interface module and the passenger information system respectively.

The main module: the function of the main module is to identify a possible operation safety risk according to acquired fault information, train operation information and train positioning information, and generate a related countermeasure on the basis of an emergency plan or a predefined rule. It includes but is not limited to through an interface with the train control system (or a critical system such as a train/platform door), forwarding a received relevant zone management and control command to the train control system (or the critical system such as the train/platform door) and locking down the relevant zone, while recording and storing a risk event log, identifying the risk, device fault state and providing risk prompt information. Meanwhile, it is used to monitor the operation process of an operation participant, and finally transmit a relevant zone unlocking command to the train control system (or the critical system such as the train/platform door) to resume the operation in time after confirming that a risk mitigation measure is executed properly.

The terminal interface module can be deployed in a handheld device or a workstation as a man-machine interface. The terminal interface module is for all kinds of participants involved in operation management: a dispatcher, a station attendant, a platform duty officer, a train worker and support staff. The terminal interface module is used to query states and positions of various devices in operation: to receive and push the device fault state, the risk prompt and safety operation process information for mitigating the risk provided by the operation management system: to accept manual confirmation information of emergency plan operation steps, so as to provide monitor information of the emergency plan operation process for the main module.

The security gateway: it is used as a security interface between the main module of the safe intelligent management and control platform for rail transit operation and the train control system (or the critical system such as the train/platform door) and is a channel to ensure the safe transmission of information.

The information release gateway: it is used to push device fault information to the passenger information system in time, so as to share emergency information in real time:

Train control system (or the critical system such as a train/platform door): it transmits the line operation state to the safe intelligent management and control platform of rail transit in real time, and accepts the zone locking command from the safe intelligent management and control platform of rail transit, timely activates the line safety protection function, and protects the safety of train and persons in the zone. Once the train control system (or the critical system such as the train/platform door) determines that the wayside device is fault, it automatically unlocks the relevant zone and transmits the relevant fault state and locking state information to the main module.

Whether it is the station personnel or the train worker, once a risk affecting the train operation or a risk occurring when passengers get on the train or land at the platform is found, the terminal interface module device can be used to select the corresponding risk event or record a risk event by means of voice. The main module of the safe intelligent management and control platform of rail transit operation transmits a command for locking down an associated platform zone or interval to the train control system (or the critical system such as the train/platform door), and transmits the information pertaining to the risk event and the relevant risk zone to the safe intelligent management and control platform of rail transit in the control center. Finally, rapid and accurate information release and rapid emergency response to the risk event are realized, the degree of risk impact is reduced to minimum and the emergency event information is simultaneously pushed to all personnels involved in the operation management.

After the station attendant executes an operation according to risk mitigation operation prompt step information provided by the terminal interface module, the main module transmits a push for requesting state confirmation to a dispatcher; and after the dispatcher confirms that the risk is relieved, the dispatcher transmits an unlocking command to the train control system (or the critical system such as the train/platform door) to resume operation in time.

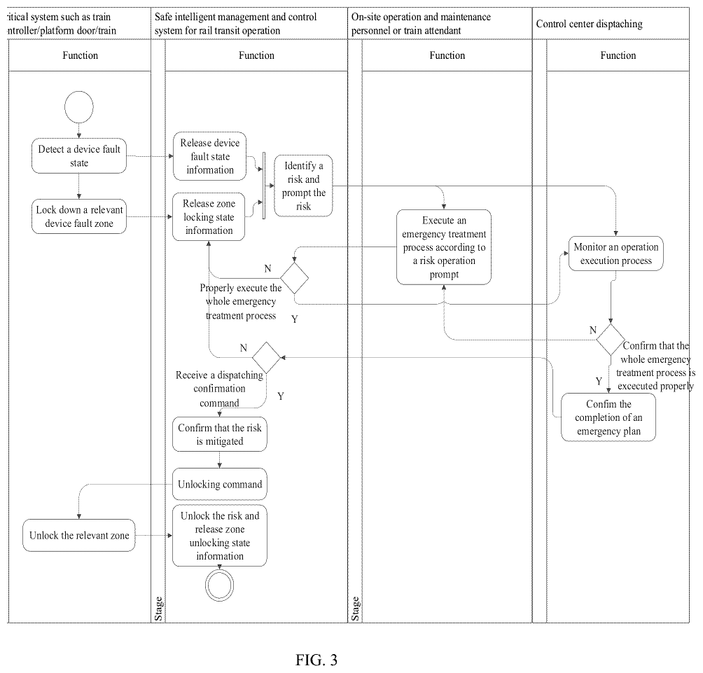

As shown in FIG. 3, the specific control process of the system of the present invention is as follows:

When the train control system (or the critical system such as the vehicle/platform door) detects a fault state of a wayside device, it transmits device fault state information to the main module of the safe intelligent management and control platform of rail transit operation. After receiving the device fault state information, the main module of the safe intelligent management and control platform of rail transit operation pushes the device fault state information to the terminal interface module in time, and pushes it through the information release gateway to the passenger information system.

After the train control system (or the critical system such as train/platform door) detects the device fault state affecting train operation, the train control system (or the critical system such as train/platform door) automatically locks down a relevant zone of the device, transmits zone locking state information to the main module of the safe intelligent management and control platform of rail transit operation, and timely pushes the zone locking state information to the terminal interface module, and pushes it through the information release gateway to the passenger information system.

The main module of the safe intelligent management and control platform of rail transit operation determines the corresponding risk and queries the corresponding fault treatment process according to the device fault state information and zone locking state information, and pushes the risk prompt information and the safe operation process information of risk mitigation to the terminal interface module, and timely notifies the on-site operation and support staff or train attendant.

After receiving the risk prompt information and the safe operation process information of risk mitigation, the on-site operation and support staff or the train attendant shall immediately execute the emergency treatment process according to the safe operation process, and transmit the safe operation steps of risk mitigation and the operation state to the main module of the safe intelligent management and control platform of rail transit operation after confirming that the safe operation process is correctly executed.

The control center dispatcher monitors and confirms the correctness of the execution process according to the safety operation process after receiving the risk prompt information and safety operation process information to mitigate the risk.

The safe intelligent management and control platform of rail transit operation transmits a request confirmation command on the completion of execution of the emergency plan to the terminal interface module of the control center dispatcher after receiving the confirmation of properly executing the whole emergency treatment process of the on-site operation and support staff or the train attendant.

After confirming the correct execution of the the whole emergency treatment process, the control center dispatcher transmits information confirming the completion of the emergency plan to the safe intelligent management and control platform of rail transit operation.

The safe intelligent management and control platform of rail transit operation, after receiving a confirmation command from the control center dispatcher for confirming the correct execution of the whole emergency treatment process, confirms the risk mitigation, stops transmitting the safety operation steps for risk mitigation and the operation state, and transmits the unlocking command for the relevant zone to the train control system (or the critical system such as the train/platform door).

After the train control system (or the critical system such as the train/platform door) receives the unlocking command for the relevant zone and unlocking state of the relevant zone from the main module of the safe intelligent management and control platform of rail transit operation, it feeds back the state of the relevant zone to the main module of the safe intelligent management and control platform of rail transit operation. The main module of the safe intelligent management and control platform of rail transit operation pushes the relevant zone risk unlocking and zone unlocking state information to the terminal interface module.

The above are only specific embodiments of the present invention, but the protection scope of the present invention is not limited to this, and any technical person familiar with the technical field can easily think of various equivalent modifications or replacements within the technical scope disclosed by the present invention, and these modifications or replacements shall be covered by the protection scope of the present invention. Therefore, the protection scope of the present invention shall be subject to the protection scope of the claims.

What is claimed is:

1. A intelligent management and control system for rail transit operation safety, wherein the system, together with a train control system, an operation and maintenance terminal and a passenger information system, monitors rail transit operation risks in real time, wherein the management and control system comprises a main module, a terminal interface module, a security gateway, and an information release gateway: the main module is connected to the terminal interface module, the security gateway, and the information release gateway respectively: the terminal interface module is connected to the operation and maintenance terminal: the security gateway is connected to the train control system; and the information release gateway is connected to the terminal interface module and the passenger information system respectively.

2. The intelligent management and control system for rail transit operation safety according to claim 1, wherein the main module identifies a possible operation safety risk according to acquired fault information, train operation information, and train positioning information, and generates a corresponding countermeasure on the basis of an emergency plan or a predefined rule.

3. The intelligent management and control system for rail transit operation safety according to claim 2, wherein the main module forwards a received relevant zone management and control command to the train control system by means of the security gateway, locks down a relevant zone, records and stores a risk event log, identifies a risk and a device fault state, and provides risk prompt information; and at the same time, the main module monitors an operation process of an operation participant, and transmits a relevant zone unlocking command to the train control system to resume operation in time after confirming that a risk mitigation measure is executed properly.

4. The intelligent management and control system for rail transit operation safety according to claim 1, wherein the terminal interface module is deployed in a handheld device or a workstation as a human-machine interface, and is used to query states and positions of various devices in operation, receive and push a device fault state, a risk prompt and safety operation process information for mitigating the risk provided by an operation management system, accept manually confirmed emergency plan operation step acknowledgment information, and provide emergency plan operation process monitoring information for the main module.

5. The intelligent management and control system for rail transit operation safety according to claim 1, wherein the security gateway, as a security interface between the main module and the train control system, is used to ensure secure information transmission.

6. The intelligent management and control system for rail transit operation safety according to claim 1, wherein the information release gateway is used to push device fault information to the passenger information system in time, so as to share emergency information in real time.

7. The intelligent management and control system for rail transit operation safety according to claim 1, wherein the train control system transmits a line operation state to the intelligent management and control system for rail transit operation safety in real time, and receives a zone locking command from the intelligent management and control system for rail transit operation safety at the same time, so as to activate a line safety protection function in time; and once the train control system determines that a wayside device is fault, the train control system automatically locks down a relevant zone and transmits a relevant fault state and locking state information to the main module.

8. The intelligent management and control system for rail transit operation safety according to claim 1, wherein the operation and maintenance terminal comprises a station personnel terminal and a train worker terminal.

9. The intelligent management and control system for rail transit operation safety according to claim 8, wherein the terminal interface module receives in real time risk information transmitted by the station personnel terminal and the train worker terminal, selects a corresponding risk event or records a risk event by means of voice, transmits a command for locking down an associated platform zone or interval to the train control system by means of the main module, and transmits information pertaining to the risk event and the relevant risk zone to a control center.

10. The intelligent management and control system for rail transit operation safety according to claim 1, wherein the operation and maintenance terminal comprises a station attendant terminal, wherein after the station attendant terminal executes an operation according to risk mitigation operation prompt step information provided by the terminal interface module, the main module transmits a push for requesting state confirmation to a dispatching terminal: and after the dispatching terminal confirms that the risk is relieved, the dispatching terminal transmits an unlocking command to the train control system to resume operation in time.
